(19) United States
(12) Patent Application Publication
(10) Pub. No.: US 2009/0287800 A1
(43) Pub. Date: Nov. 19, 2009

(54) METHOD, DEVICE AND SYSTEM FOR MANAGING NETWORK DEVICES

(76) Inventors: Haixia Chi, Shenzhen (CN); Yi Sun, Shenzhen (CN); Junchen Lai, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/394,126

(22) Filed: Feb. 27, 2009

(30) Foreign Application Priority Data
May 15, 2008 (CN) 200810097596.6

(51) Int. Cl. G06F 15/177

(52) U.S. Cl. 709/220

(57) ABSTRACT

A method for managing network devices includes: after detecting that a primary network device is connected to a network management device, sending an information query to a secondary network device to query the management configuration information of the primary network device; receiving response information sent by the secondary network device in response to the information query, where the response information includes the management configuration information of the primary network device; using the management configuration information to manage the primary network device.

This application claims priority to Chinese Patent Application no. 200810097596.6, entitled “METHOD, DEVICE AND SYSTEM FOR MANAGING NETWORK DEVICES” and filed with the Chinese Patent Office on May 15, 2008, which is hereby incorporated by reference in its entirety. FIELD

The present invention relates to the field of device management, in particular, to a method, device and system for managing network devices.

### BACKGROUND

With fast development of information technologies, communication technologies and networks give rise to miscellaneous networks, network management devices and network devices. A network management device manages network devices in a network. However, network devices are diversified, and each different network device supports different functions or supports the same function in different ways.

In a related art, in order for a network management device to support diversified network devices, the developer needs to understand the types and functions of the network device types that need to be supported before developing the network management device. In the process of developing the network management device, the management configuration information of the network device is stored in the network management device by certain means such as configuration files and record databases. After the network management device is put into operation, the network management device manages network devices according to the stored management configuration information.

The existing network management devices may only manage a type of network device preconfigured with the management configuration information, but may not manage all types of network devices; therefore, the management is not flexible.

### SUMMARY

In one embodiment, a network device management method is provided. The network device management method includes: after detecting that a primary network device is connected, sending an information query to a secondary network device to query the management configuration information of the primary network device; receiving response information from the secondary network device in response to the information query, where the response information includes the management configuration information of the primary network device; and using the management configuration information to manage the primary network device.

In one embodiment, the network device management device includes a detecting unit, an information querying unit, an information receiving unit, and a device management unit. The detecting unit is adapted to detect whether a primary network device is connected. The information querying unit is adapted to send an information query to the secondary network device to query the management configuration information of the primary network device after detecting that the primary network device is connected. The information receiving unit is adapted to receive response information from the secondary network device in response to the information query after the information querying unit sends an information query to the secondary network device to query the management configuration information of the primary network device, where the response information includes the management configuration information of the primary network device. The device management unit is adapted to use the management configuration information to manage the primary network device.

According to some embodiments of the present invention, the network management device may send a query for the management configuration information to a network device rather than a network management device to obtain the management configuration information of the network device, and use the management configuration information to manage the network device. Therefore, even if no management configuration information corresponding to the network device is stored, the network management device may also obtain the management configuration information of the network device to manage the network devices of new types, thus making the network device management more flexible.

### BRIEF DESCRIPTION OF THE DRAWINGS

FIG. 1 shows a flowchart of the network device management method in a first embodiment of the present invention;

FIG. 2 shows a flowchart of the network device management method in a second embodiment of the present invention;

FIG. 3 shows a flowchart of the network device management method in a third embodiment of the present invention;

FIG. 4 shows a flowchart of the network device management method in a fourth embodiment of the present invention;

FIG. 5 shows a flowchart of the network device management method in a fifth embodiment of the present invention;

FIG. 6 shows a structure of a network management device in the first embodiment of the present invention;

FIG. 7 shows a structure of a network management device in the second embodiment of the present invention;

FIG. 8 shows a structure of a network management device in the third embodiment of the present invention;

FIG. 9 shows a structure of a network device in the first embodiment of the present invention;

FIG. 10 shows a structure of a network device in the second embodiment of the present invention;

FIG. 11 shows a network system in the first embodiment of the present invention; and

FIG. 12 shows a network system (namely, signaling flow) in the second embodiment of the present invention.

### DETAILED DESCRIPTION

The present invention is hereinafter described in detail by reference to accompanying drawings and exemplary embodiments.

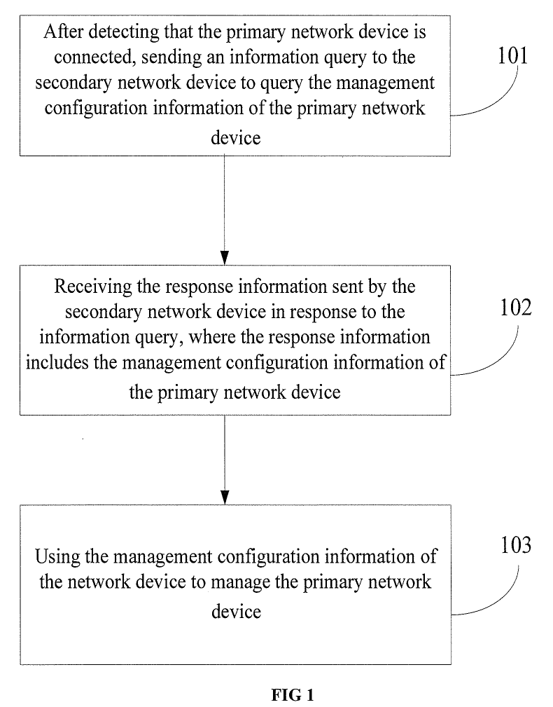

FIG. 1 shows a network management method in the first embodiment of the present invention. The method includes the following steps:

Step 101: After detecting that a primary network device is connected, a network management device sends an information query to a secondary network device to query management configuration information of the primary network device.

In the embodiment, the primary network device is relative to the secondary network device. The primary network device refers to an object whose management configuration information is queried; and the secondary network device may be the primary network device itself, or an object which includes the primary network device and other network management devices or servers. The primary network device, other network management devices or servers may be called a network device, and may be called a secondary network device only if the management configuration information can be queried from them, which is the same hereinafter. The information query is sent by the network management device to the secondary network device for obtaining the management configuration information of the primary network device. The information query may be a newly added query, or an extension of an old query. The embodiment of the present invention does not limit the information query to a particular type of query. Any information query should be applicable in the embodiment as long as it seeks the management configuration information of the primary network device. A “new” primary network device means that the primary network device is newly added, and the device type is not known by the network management device. A “type” here does not necessarily refer to a model. The network device of the same “model” but different version may be characterized as a different type. The categorization of a “type” in the embodiment of the present invention is based on the difference of functionalities supported by the primary network device.

Step 102: The network management device receives response information sent by the secondary network device in response to the information query in step 101, where the response information includes the management configuration information of the primary network device.

The management configuration information in the embodiment of the present invention may include: functions supported by the primary network device, for example, setting and querying security shielding states, setting and querying security reporting, setting and querying security relevance suppression, security resolution data, and possibly other information.

Step 103: The network management device uses the management configuration information to manage the primary network device.

In the embodiment of the present invention, the network device may send a query for the management configuration information to obtain the management configuration information of the primary network device, and use the management configuration information to manage the primary network device. Therefore, even if no management configuration information corresponding to the primary network device is stored, the network management device may also obtain the management configuration information of the primary network device to manage the new type of primary network device.

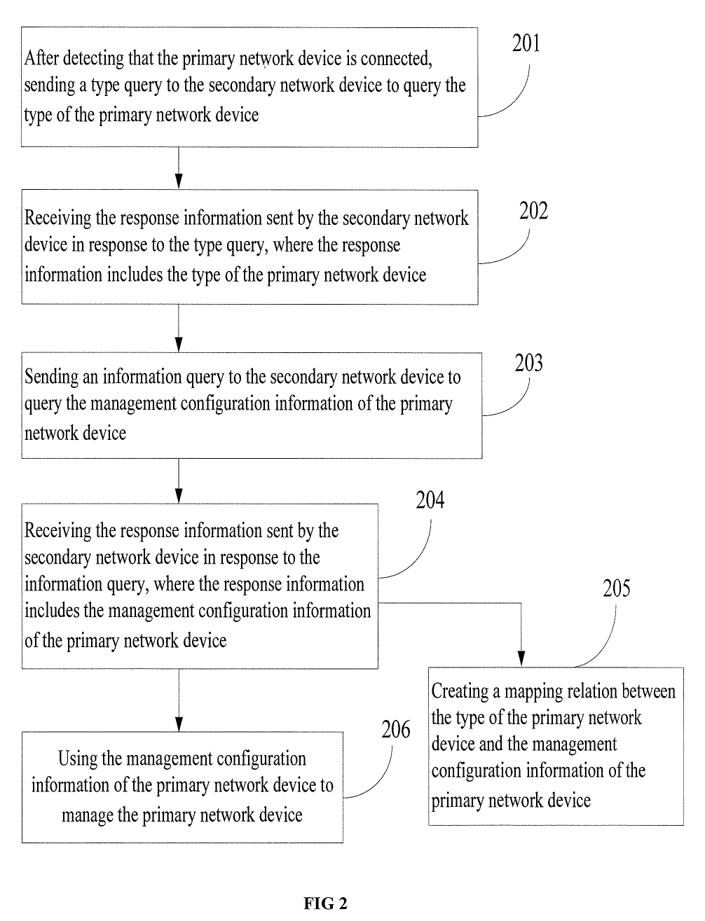

FIG. 2 shows a network device management method in the second embodiment of the present invention. The method includes:

Step 201: After detecting that a new primary network device is connected, a network management device sends a type query to a secondary network device to query the type of the primary network device.

Like the first embodiment of the network device management method, the primary network device is related to the secondary network device. The primary network device refers to an object whose management configuration information is queried; and the secondary network device may be the primary network device itself, or an object which includes the primary network device and other network management devices or servers. The primary network device, other network management devices or servers may be called a network device, and may be called a secondary network device if the type of the primary network device can be queried from them, which is the same hereinafter.

Step 202: The network management device receives response information sent by the secondary network device in response to the type query in step 101, where the response information includes the type of the primary network device.

Step 203: The network management device sends an information query to the secondary network device to query the management configuration information of the primary network device.

Step 204: The network management device receives the response information sent by the secondary network device in response to the information query in step 203, where the response information includes the management configuration information of the primary network device.

Step 205: The network management device creates a mapping relation between the type of the primary network device received in step 202 and the management configuration information of the primary network device received in step 204. The network management device may store the mapping relation, and may analyze the management configuration information primary for ease of storing and reading.

Step 206: The network management device uses the management configuration information to manage the primary network device.

In the embodiment, the type query is sent by the network management device to the secondary network device to seek the type of the primary network device. The type query may be a newly added query, or an extension of an old query. The embodiment does not restrict the type query, and any type query is applicable in the embodiment as long as it seeks a network device type. In step 205, the mapping relation is created in order to manage the primary network device connected subsequently: when the network management device is connected to a new primary network device, the network management device may search for the management configuration information in the mapping relation with the type of the new primary network device inside the network management device. In this way, the network management device avoids the trouble of querying the management configuration information of each specific primary network device. The type-related step 201 and step 202 may occur before or after steps 203 and 204 related to the management configuration information. The type may be obtained before or after the management configuration information is obtained, or the type and the management configuration information are obtained simultaneously. The sequence of performing such steps is not limited in the embodiment of the invention.

In the embodiment, the network management device uses the received management configuration information to manage the connected primary network device, and creates a mapping relation between the type of the primary network device and the management configuration information of the primary network device. This process may be regarded as an initialization process of retrieving management configuration information when the network management device is initially put into use. This process provides a management configuration information library for the network management device to manage subsequently connected primary network devices, so that the network management device may manage other primary network devices of the same type.

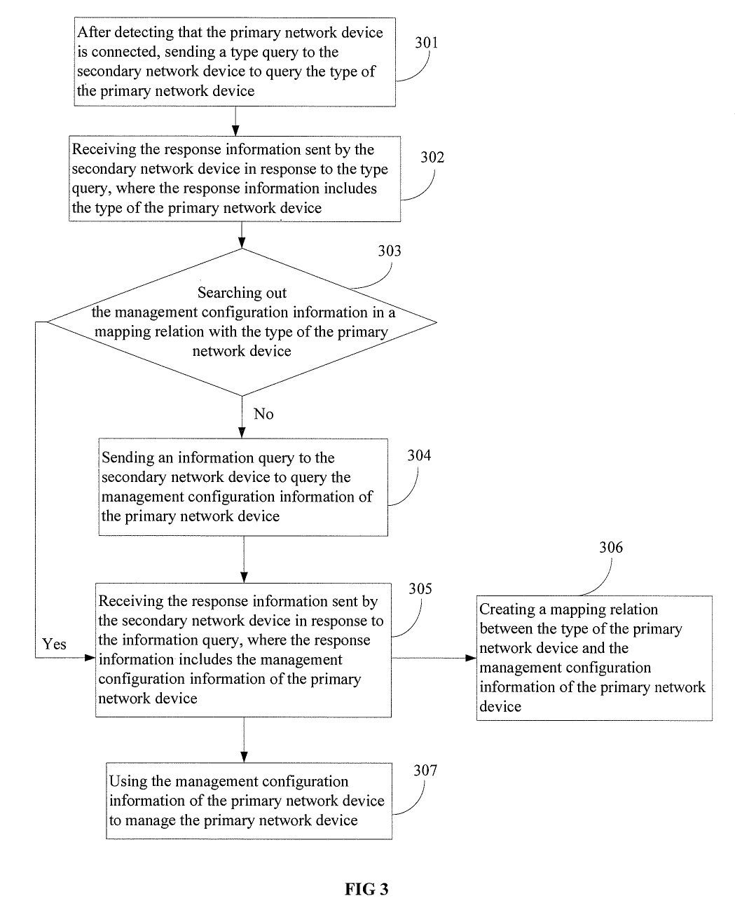

FIG. 3 shows a network management method in the third embodiment of the present invention. The method includes:

Step 301: A network management device sends a type query to a secondary network device to query the type of the primary network device.

Step 302: The network management device receives response information sent by the secondary network device in response to the type query, where the response information includes the type of the primary network device.

Step 303: The network management device searches for the management configuration information in a mapping relation with the type of the primary network device among the created mapping relations.

If no management configuration information in a mapping relation with the type is found, the process proceeds to the following step:

Step 304: The network management device sends an information query to the secondary network device to query the management configuration information of the primary network device.

Step 305: The network management device receives response information sent by the secondary network device in response to the information query in step 304, where the response information includes the management configuration information of the primary network device.

Step 306: The network management device creates a mapping relation between the type and the management configuration information of the primary network device.

Step 307: The network management device uses the management configuration information in the mapping relation with the type of the primary network device to manage the primary network device.

If any management configuration information in a mapping relation with the type is found, the process proceeds to step 307.

In the embodiment, the primary network devices connected with the network management device may be in two situations: (i) The mapping relation is already created between the management configuration information and the type of the primary network device, and the network management device may use the management configuration information in a mapping relation with the type of the primary network device to manage the primary network device directly. The mapping relation may be stored in the network management device in the manufacturing process. Particularly, the manufacturer may create the mapping relation between the type of commonly used primary network devices and the management configuration information of the primary network device, and store the mapping relation in the network management device as an inherent part of the network management device. Alternatively, the network management device may create the mapping relation dynamically after being put into use; (ii) No mapping relation is created between the management configuration information and the type of the primary network device. In this case, the network management device queries and receives the management configuration information, and creates the mapping relation. The network management device may manage the primary network devices of the same type and the primary network devices of a new type.

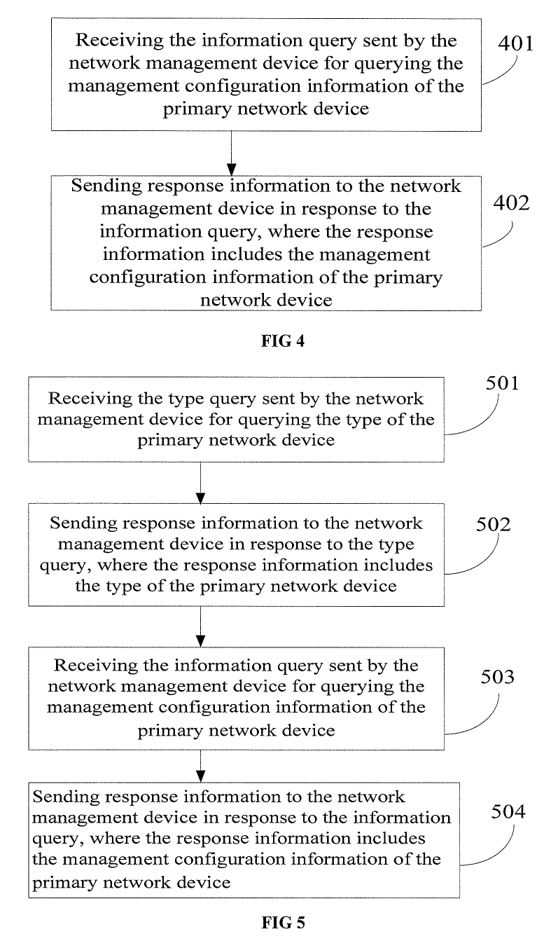

FIG. 4 shows a network management method in the fourth embodiment of the present invention. The method includes:

Step 401: A secondary network device receives an information query sent by a network management device for management configuration information of a primary network device.

Step 402: The secondary network device sends response information to the network management device in response to the information query in step 401, where the response information includes the management configuration information of the primary network device.

In this embodiment, the secondary network device can provide management configuration information that includes data and formats stipulated uniformly in a specific field such as an industrial field or a manufacturer field, maintain the management configuration information with the unified format and contents, and use unified modes in querying, sending, and receiving management configuration information and the type of the primary network device. In this way, the primary network device of the new type can be managed by the network management device conveniently.

FIG. 5 shows a network management method in the fifth embodiment of the present invention. The method includes:

Step 501: A secondary network device receives a type query sent by a network management device for the type of a primary network device.

Step 502: The secondary network device sends response information to the network management device in response to the type query, where the response information includes the type of the primary network device.

Step 503: The secondary network device receives the information query sent by the network management device for the management configuration information of the primary network device.

Step 504: The secondary network device sends response information to the network management device in response to the information query, where the response information includes the management configuration information of the primary network device.

In the embodiment, a mapping relation already exists, which facilitates the network management device to search for the management configuration information. If no such information is found, a new mapping relation may be created. Namely, the network management device may interconnect the primary network devices of new types which increase continuously. For the subsequently connected primary network devices of the same type, the network management device manages them directly through the existing management configuration information for which a mapping relation has been created. The secondary network device enables the network management device to perform management by sending type information, or by sending type information and management configuration information.

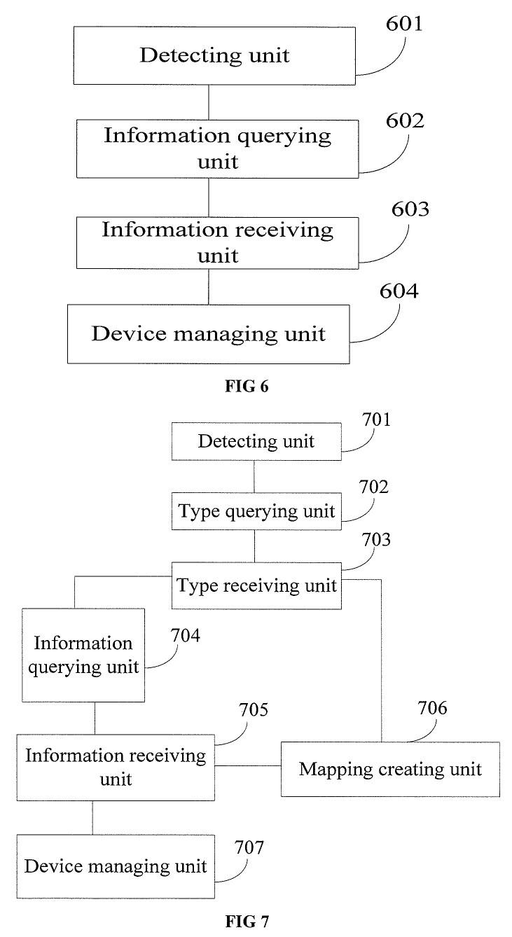

FIG. 6 shows a network management device in the first embodiment of the present invention. The network management device includes: a detecting unit 601, adapted to detect whether a primary network device is connected; an information querying unit 602, adapted to send an information query to a secondary network device to query the management configuration information of the primary network device if the detecting unit 601 detects that the primary network device is connected; an information receiving unit 603, adapted to receive response information from the secondary network device in response to the information query after the information querying unit 602 sends an information query to the secondary network device to query the management configuration information of the primary network device, where the response information includes the management configuration information of the primary network device; and a device management unit 604, adapted to use the management configuration information received by the information receiving unit 603 to manage the primary network device.

In the embodiment, the network management device obtains the management configuration information through an information querying unit and an information receiving unit; the device management unit further uses the management configuration information to manage the primary network device. Therefore, even if no management configuration information corresponding to the primary network device is stored, the network management device may also obtain the management configuration information corresponding to the primary network device to manage the primary network device, and the network management device can manage primary network devices of new types.

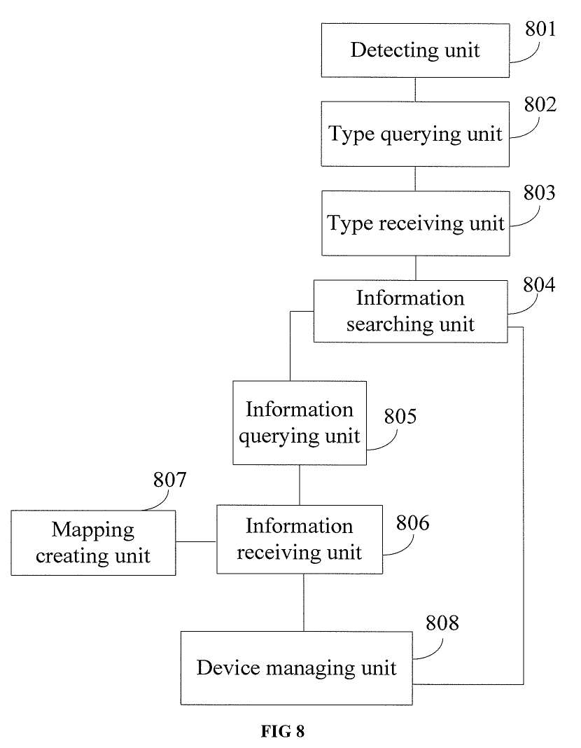

FIG. 7 shows a network management device in the second embodiment of the present invention. The network management device includes: a detecting unit 701, adapted to detect whether a primary network device is connected; a type querying unit 702, adapted to send a type query to the secondary network device to query the type of the primary network device if the detecting unit 701 detects that the primary network device is connected; a type receiving unit 703, adapted to receive response information from the secondary network device in response to the type query after the type querying unit 702 sends a type query to the secondary network device to query the type of the primary network device, where the response information includes information on the type of the primary network device; an information querying unit 704, adapted to send an information query to the secondary network device to query the management configuration information of the primary network device after the detecting unit 701 detects the primary network device; an information receiving unit 705, adapted to receive the response information from the secondary network device in response to the information query sent by the information querying unit 704, where the response information includes the management configuration information of the primary network device; a mapping creating unit 706, adapted to create a mapping relation between the type of the primary network device and the management configuration information of the primary network device; and a device management unit 707, adapted to use the management configuration information of the primary network device to manage the primary network device.

The network management device in this embodiment has additional units such as type querying unit 702, type receiving unit 703, and mapping creating unit 706. Through the type querying unit 702, type receiving unit 703, information querying unit 704, and information receiving unit 705, the network management device searches for the type of the primary network device and the corresponding management configuration information, and uses the mapping creating unit 706 to create a mapping relation between the type of the primary network device and the corresponding management configuration information. The network management device may perform an initialization process of retrieving management configuration information and creating a mapping relation when the network management device is initially put into use. This process provides a management configuration information library for the network management device to manage subsequently connected network devices, so that the network management device may manage other primary network devices of the same type, thus improving the capability of the network management device interconnecting with the primary network devices of new types.

FIG. 8 shows a network management device in the third embodiment of the present invention. The network management device includes: a detecting unit 801, adapted to detect whether a primary network device is connected; a type querying unit 802, adapted to send a type query to the secondary network device to query the type of the primary network device if the detecting unit 801 detects that the primary network device is connected; a type receiving unit 803, adapted to receive response information from the secondary network device in response to the type query sent by the type querying unit 802, where the response information includes information on the type of the primary network device; an information searching unit 804, adapted to search for the management configuration information in a mapping relation with the type of primary network device according to the mapping relation created by a mapping creating unit 807 after the type receiving unit 803 receives the type of the primary network device; an information querying unit 805 is adapted to send an information query to the secondary network device to query the management configuration information of the primary network device, when the information searching unit 804 finds no management configuration information in a mapping relation with the type of the primary network device; an information receiving unit 806, adapted to receive the response information from the secondary network device in response to the information query sent by the information querying unit 805, where the response information includes the management configuration information of the primary network device; the mapping creating unit 807, adapted to create a mapping relation between the type of the primary network device and the received management configuration information of the primary network device; and a device management unit 808, adapted to use the management configuration information in a mapping relation with the type of the primary network device to manage the primary network device.

The device management unit 808 uses the management configuration information to manage the primary network device when the information searching unit 804 finds any management configuration information in a mapping relation with the type of the primary network device.

In the embodiment, the primary network devices connected with the network management device may be in two situations: (i) The management configuration information of the primary network device is stored in the network management device, and a mapping relation is already created between the management configuration information and the type of the primary network device, and the network management device may use the management configuration information to manage the primary network device directly. The mapping relation may be stored in the network management device in the manufacturing process. Particularly, the manufacturer may create a mapping relation between the type of commonly used primary network devices and the management configuration information of the primary network device, and store the mapping relation in the network management device as an inherent part of the network management device. Alternatively, the network management device may create the mapping relation dynamically after being put into use. (ii) No management configuration information of the primary network device is stored in the network management device, and no mapping relation is created between the management configuration information and the type of the primary network device. In this case, the network management device queries and receives the management configuration information, and creates a mapping relation. The network management device may be flexible to manage the primary network devices of the same type and the primary network devices of a new type.

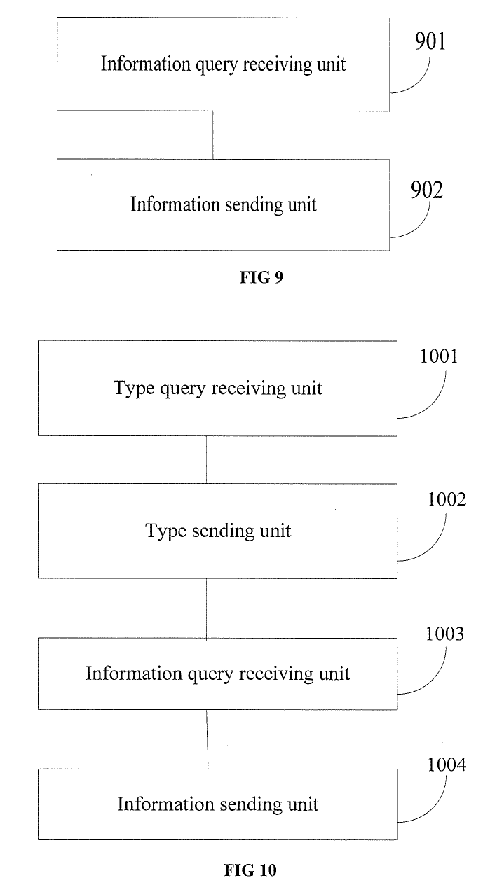

FIG. 9 shows a network device in the first embodiment of the present invention, where the information query receiving unit 901 is adapted to receive an information query sent by the network management device for querying the management configuration information of the primary network device.

The information sending unit 902 is adapted to send response information to the network management device in response to the information query received by the information query receiving unit 901, where the response information includes the management configuration information of the primary network device.

In this embodiment, the network device refers to the secondary network device. The primary network device is relative to the secondary network device. A primary network device refers to an object whose management configuration information is queried; and a secondary network device may be the primary network device itself, or an object which includes the primary network device and other network management devices or servers. The primary network device, other network management devices or servers may be called a network device, or may be called a secondary network device if management configuration information can be queried from them, which is the same hereinafter. The secondary network device can provide management configuration information that includes data and formats stipulated uniformly in a specific field such as an industrial field or a manufacturer field, maintain the management configuration information with the unified format and contents, and use unified modes in querying, sending, and receiving management configuration information and the type of the primary network device. In this way, the primary network devices of different types in a specific field can be managed by the network management device conveniently.

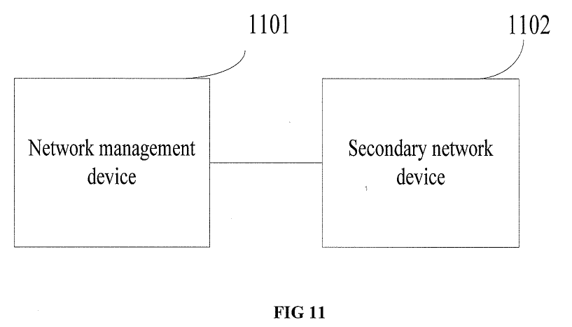

FIG. 10 shows a network device in the second embodiment of the present invention. The network device includes: a type query receiving unit 1001, adapted to receive a type query sent by the network management device for querying the type of the primary network device; a type sending unit 1002, adapted to send response information to the network management device in response to the type query received by the type query receiving unit 1001, where the response information includes the type of the primary network device; an information query receiving unit 1003, adapted to receive an information query sent by the network management device for querying the management configuration information of the primary network device; and an information sending unit 1004, adapted to send response information to the network management device in response to the information query received by the information query receiving unit 1003, where the response information includes the management configuration information of the primary network device.

In the embodiment, a mapping relation already exists, which facilitates the network management device to search for the management configuration information. If no such information is found, a new mapping relation may be created. Namely, the network management device may interconnect the primary network devices of new types which may increase continuously. For the subsequently connected primary network devices of the same type, the network management device manages them through the existing management configuration information. The secondary network device interconnects with the network management device conveniently by sending type information, or by sending type information and management configuration information.

FIG. 11 shows a network system provided in the first embodiment of the present invention. The network system includes: a network management device 1101, adapted to send an information query to a secondary network device 1102 to query the management configuration information of a primary network device after detecting that the primary network device is connected, receive response information sent by the secondary network device 1102 in response to the information query, the response information including the management configuration information of the primary network device and use the management configuration information to manage the primary network device; and the secondary network device 1102, adapted to receive the information query sent by the network management device 1101 for querying the management configuration information of the primary network device and send response information to the network management device 1101 in response to the information query, the response information including the management configuration information of the primary network device.

The secondary network device 1102 may be the primary network device itself

In the embodiment, the network management device queries the management configuration information for all connected primary network devices in a specified way, the secondary network device sends the found management configuration information to the network management device in a specified way, and the network management device receives the management configuration information in a specified way. In the network management system in the embodiment, the network management device in a specific field may manage the primary network device of a new type in the specific field.

In a network system, the network management device 1101 is further adapted to send a type query to the secondary network device 1102 to query the type of the primary network device; receive response information sent by the secondary network device 1102 in response to the type query, where the response information includes information on the type of the primary network device; search for the management configuration information in a mapping relation with the type of the primary network device according to the received type of the primary network device; send an information query to the secondary network device 1102 to query the management configuration information of the primary network device, when no management configuration information in a mapping relation with the type of the primary network device is found; receive response information in response to the information query, where the response information includes the management configuration information of the primary network device; create a mapping relation between the type of the primary network device and the management configuration information of the primary network device; use the management configuration information to manage the primary network device; use the management configuration information in a mapping relation with the type of the primary network device to manage the primary network device, when any management configuration information in a mapping relation with the type of the primary network device is found.

The secondary network device 1102 is further adapted to receive a type query from the network management device 1101 for querying the type of the primary network device; and send response information in response to the type query, where the response information includes the type of the primary network device.

That is to say, in the foregoing solution, the network management device creates a mapping relation between the found type of the primary network device and the corresponding management configuration information. For subsequently connected primary network devices of the same type, the network management device search for the management configuration information in a mapping relation with the type of the primary network device. If any such management configuration information is found, the network management device uses the management configuration information to manage the primary network device. If no such information is found, the network management device queries the secondary network device for the management configuration information, and then creates a mapping relation between the type of the primary network device and the management configuration information. This process recurs again and again so that the network management device can manage the primary network devices of new types.

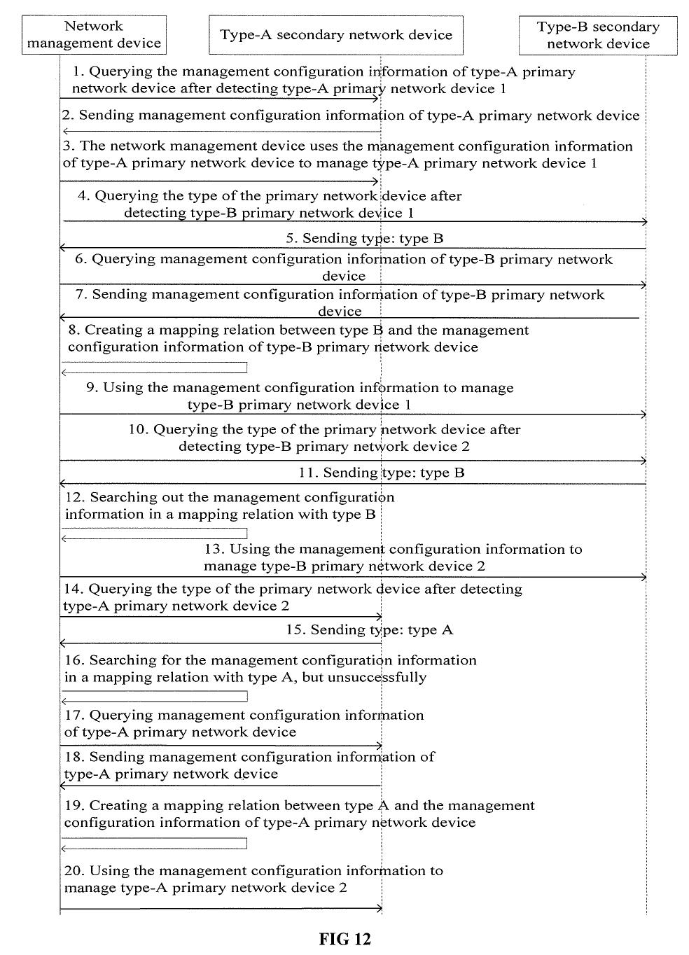

FIG. 12 shows a network system and a method of managing the network system in the second embodiment of the present invention. The network system and the method include:

Step 1 to step 3 are about dynamic interaction without mapping relation.

Step 1: After detecting that a type-A primary network device 1 is connected, the network management device queries a type-A secondary network device for the management configuration information of type-A primary network device.

Step 2: The type-A secondary network device sends the management configuration information of the type-A primary network device to the network management device.

Step 3: The network management device uses the management configuration information of type-A primary network device to manage type-A primary network device

Steps 4˜9 are about dynamic interaction of creating a mapping relation initially.

Step 4: After detecting the type-B primary network device 1, the network management device queries a type-B secondary network device for the type of the type-B primary network device.

Step 5: The type-B secondary network device sends “type B” to the network management device.

Step 6: The network management device queries the management configuration information of the type-B primary network device.

Step 7: The type-B secondary network device sends the management configuration information of the type-B primary network device to the network management device.

Step 8: The network management device creates a mapping relation between the type-B primary network device and the management configuration information of the type-B primary network device.

Step 9: The network management device uses the management configuration information of the type-B primary network device to manage type-B network device 1.

The foregoing step 4 and step 5 for obtaining the type may occur before or after steps 6 and 7 for obtaining the management configuration information. The type may be obtained before or after the management configuration information, or the type and the management configuration information are obtained simultaneously.

Steps 10˜13 are about dynamic interaction that occurs when management configuration information can be found.

Step 10: After detecting the type-B primary network device 2, the network management device queries the type-B secondary network device for the type of the type-B primary network device.

Step 11: The type-B secondary network device sends “type B” to the network management device.

Step 12: The network management device finds the management configuration information in a mapping relation with the type-B primary network device.

Step 13: The network management device uses the management configuration information of the type-B primary network device to manage type-B primary network device 2.

Steps 14˜20 are about dynamic interaction that occurs when no management configuration information is found.

Step 14: After detecting the type-A primary network device 2, the network management device queries the type-A secondary network device for the type of the type-A primary network device.

Step 15: The type-A secondary network device sends “type A” to the network management device.

Step 16: The network management device searches for the management configuration information in a mapping relation with the type-A primary network device, but fails.

Step 17: The network management device queries type-A secondary network device for the management configuration information of the type-A primary network device.

Step 18: The type-A secondary network device sends the management configuration information of the type-A primary network device to the network management device.

Step 19: The network management device creates a mapping relation between the type-A primary network device and the management configuration information.

Step 20: The network management device uses the management configuration information of the type-A primary network device to manage type-A primary network device 2.

The steps in the embodiment should not restrict the implementation process of the present invention. In the embodiment, a network management device can manage new types of network devices.

It is understandable to those skilled in the art that all or partial steps of the preceding embodiments can be implemented by hardware instructed by programs. The programs may be stored in a computer readable storage medium. When such programs are running, the process includes the following steps: sending an information query to the secondary network device to query the management configuration information of the primary network device after detecting that the primary network device is connected; receiving the response information sent by the secondary network device in response to the information query, where the response information includes the management configuration information of the primary network device; and using the management configuration information to manage the primary network device; and/or the following steps: receiving the information query sent by the network management device for querying the management configuration information of the primary network device; and sending response information to the network management device in response to the information query, where the response information includes the management configuration information of the primary network device.

In the embodiments of the invention, the network device may maintain the management configuration information with unified formats and contents according to the data types and formats included in the management configuration information stipulated uniformly in a specific field such as an industrial field or a manufacturer field, and use unified modes in querying, sending and receiving management configuration information and the type of the network device. That is to say, the network management device and the network device have mutually corresponding modes of querying, sending and receiving management configuration information and network device type (for example, querying through a file path, FTP, or response queries, sending through character streams), and the general management configuration information of the uniform format is applied. In this way, the coupling between the network management system and the network device is simplified, and the network management system can manage unknown devices which comply with the specifications, thus improving the capability of interconnection between the network management device and the network device. Moreover, it is not necessary to maintain much management configuration information, thus improving the maintainability of the network management system and reducing the maintenance costs.

Detailed above are a method, device and system for managing network devices in embodiments of the present invention. Although the invention is described through some exemplary embodiments, the invention is not limited to such embodiments. It is apparent that those skilled in the art can make various modifications and variations to the invention without departing from the spirit and scope of the invention.

We claim:

1. A network device management method, comprising:
sending an information query to a secondary network device to query management configuration information of a primary network device if detecting that the primary network device is connected to a network management device;
receiving response information sent by the secondary network device in response to the information query, wherein the response information comprises the management configuration information of the primary network device; and
using the management configuration information to manage the primary network device.

2. The network device management method according to claim 1, further comprising:
sending a type query to query a type of the primary network device to the secondary network device after detecting that the primary network device is connected to a network management device;
receiving response information sent by the secondary network device in response to the type query, wherein the response information comprises information on the type of the primary network device; and
establishing a mapping relation between the type of the primary network device and the management configuration information of the primary network device.

3. The network device management method according to claim 2, wherein after receiving the response information sent by the secondary network, the method further comprises:
querying the management configuration information in the mapping relation with the type of primary network device;
entering a step of sending a query to query the management configuration information of the primary network device to the secondary network device if the management configuration information in the mapping relation with the type of primary network device is not queried; and
using the management configuration information in the mapping relation with the type of primary network device to manage the primary network device.

4. The method according to claim 1, wherein the secondary network device and the primary network device is the same network device.

5. The method according to claim 4, wherein the secondary network device further comprises other network management device or server.

6. A network management device, comprising:
a detecting unit, adapted to detect whether a primary network device is connected to the network management device;
an information querying unit, adapted to send an information query to a secondary network device to query management configuration information of the primary network device when detecting that the primary network device is connected;
an information receiving unit, adapted to receive response information from the secondary network device in response to the information query after the information querying unit sends the information query to the secondary network device to query management configuration information of the primary network device, wherein the response information comprises the management configuration information of the primary network device; and
a device management unit, adapted to use the management configuration information to manage the primary network device.

7. The network management device according to claim 6, further comprising:
a type querying unit, adapted to send a type query to the secondary network device to query a type of the primary network device after the detecting unit detects that the primary network device is connected to the network management device;
a type receiving unit, adapted to receive response information from the secondary network device in response to the type query after the type querying unit sending the type query to the secondary network device to query the type of the primary network device, wherein the response information comprises information on the type of the primary network device; and
a mapping creating unit, adapted to create a mapping relation between the type of the primary network device and the management configuration information of the primary network device.

8. The network management device according to claim 6, further comprising:
an information searching unit, adapted to search for the management configuration information in the mapping relation with the type of primary network device according to the mapping relation created by the mapping creating unit after the type receiving unit receives the information on the type of the primary network device;
the information querying unit, adapted to send the information query to the secondary network device to query the management configuration information of the primary network device when the information searching unit finds no management configuration information in a mapping relation with the type of the primary network device; and
the device management unit, adapted to use the management configuration information in the mapping relation with the type of the primary network device to manage the primary network device when the information searching unit finds the management configuration information in the mapping relation with the type of the primary network device.

9. The network management device according to claim 6, wherein the primary network device and the secondary network device is the same network device.

10. The network management device according to claim 9, wherein the secondary network device further comprises other network management device or server.

11. A computer readable storage medium including code for sending an information query to a secondary network device to query management configuration information of a primary network device when detecting that the primary network device is connected to a network management device; receiving response information sent by the secondary network device in response to the information query, wherein the response information comprises the management configuration information of the primary network device; and using the management configuration information to manage the primary network device.

12. The computer readable storage medium according to claim 11, further including code for sending a type query to query a type of the primary network device to the secondary network device after detecting that the primary network device is connected to the network management device; receiving response information sent by the secondary network device in response to the type query, wherein the response information comprises information on the type of the primary network device; and establishing a mapping relation between the type of the primary network device and the management configuration information of the primary network device.
